(19) United States
(12) Patent Application Publication
(10) Pub. No.: US 2009/0014973 A1
(43) Pub. Date: Jan. 15, 2009

(54) Movable Support for a Waste Container

(76) Inventor: Ray Lawless, Ashbourne (IE)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 11/990,416

(22) PCT Filed: Aug. 11, 2006
(86) PCT No.: PCT/EP2006/056262

§ 371 Date: Feb. 12, 2008

(30) Foreign Application Priority Data
Aug. 12, 2005 (IE) S2005/0529

(51) Int. Cl. B62B 1/00

(52) U.S. Cl. 280/47.26

(57) ABSTRACT

A moveable support for a waste container such as a skip, which has a frame for supporting the waste container. The frame has a base on which the waste container can sit. The frame is mounted on wheels to enable the waste container to be relocated while supported by the moveable support.

This invention relates to a moveable support for use with a waste container typically for building waste and/or rubble. The invention relates to a moveable support more particularly, but not exclusively, for use with a skip for building waste and/or rubble.

A waste container, such as a skip is used on a construction or building site to temporarily store and remove waste material such as building waste and/or rubble. A skip can also be used by other businesses and households, for the storage and disposal of waste.

The skip is heavy and is transported to and from sites by a suitable truck. The skip is difficult to manoeuvre once it has been set down on a site due to its weight and bulk. As waste is added to the skip it becomes heavier. Therefore, usually the skip remains at the same location on site until it is removed by the truck.

Furthermore, the initial positioning of the skip is restricted by the ability of the truck to enter certain areas of the site. In particular, on a construction site where there is a large amount of equipment and material the placement of the skip may be restricted to certain areas by these obstructions. Generally, the skip can only be placed outside a building due to restrictions maneuvering the truck. For example, it can be difficult for the truck to enter a basement car park or other area, where there is inadequate clearance to accommodate the height of the truck.

During a building renovation there may be a substantial volume of waste material to be removed from inside the building. Consequently, a large amount of time is spent carrying waste from the site of the renovations to the skip, particularly if the skip is located a distance from the building.

The positioning of the skip at a significant distance from the source of the waste can also increase the risk of secondary contamination while the waste is being transported to the skip.

Sometimes a building modular waste chute is used to enable easy vertical transportation of waste from inside a building into the skip located at a lower level outside. If the chute inlet is not located close to the source of waste, additional routing of waste within buildings is necessary increasing the risk of secondary contamination. In order to position the chute close to the source of waste it may be necessary to move the chute to another location. If the skip is not positioned directly under the chute and cannot be moved, it is necessary to increase the length of the chute to position the chute outlet above the skip. Such a longer chute may be more susceptible to blocking.

In accordance with a first aspect of the invention, there is provided a moveable support, for a waste container, comprising a frame for supporting the waste container comprising a base and mobilising means.

Preferably the waste container comprises a skip.

Preferably, the mobilising means comprises at least one wheel. Alternatively or additionally, the mobilising means comprises at least one roller. Alternatively or additionally, the mobilising means comprises tracks. Advantageously, the moveable support further comprises at least one leg extending from an underside of the moveable frame to slightly above a lower surface of the mobilising means.

The legs on the moveable frame are a safety feature and support the frame if the wheels, tracks or rollers collapse or break. The legs extend to just above the bottom of the wheels, tracks or rollers so that they do not obstruct the movement of the moveable frame.

Preferably, at least one of the at least one leg comprises an adjustable leg. More preferably, the adjustable leg is a screw adjustable leg.

Adjustable legs can be lengthened to facilitate supporting the moveable frame by taking the weight of the frame and the skip. The legs can be retracted so as to impede the movement of the moveable frame.

Preferably, the moveable support comprises a tow bar.

The tow bar enables the moveable support to be easily secured to a vehicle and be towed or pushed to another location by the vehicle.

Preferably, the frame comprises a rectangular frame.

More preferably, longitudinal sides of the frame are adjustable in length.

Advantageously, lateral sides of the frame are adjustable in length.

The adjustable sides of the frame enable different sizes of waste container or skip to be accommodated in the frame.

Preferably, the frame comprises cross bars. Preferably, the frame comprises removable cross bars.

Desirably, the moveable support comprises lugs being attachable to a lifting means.

Preferably, the moveable support comprises a magnetisation means. More preferably, the magnetisation means comprises an electromagnet, which is selectively actuable. The magnetisation means may be arranged to lock the moveable support to the waste container in use.

The moveable support may comprise a drive means connected to the mobilising means. The drive means may be an electric motor or a combustion engine.

Embodiments of the present invention will now be described, by way of example only, with reference to the accompanying drawings, in which:

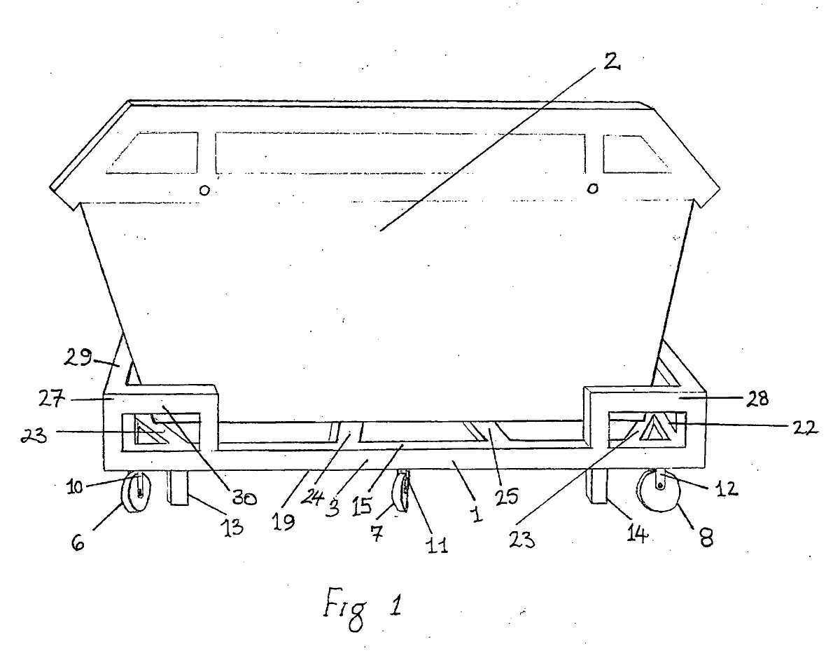

FIG. 1 is a side perspective view of a first embodiment of a moveable support according to an aspect of the present invention and a skip;

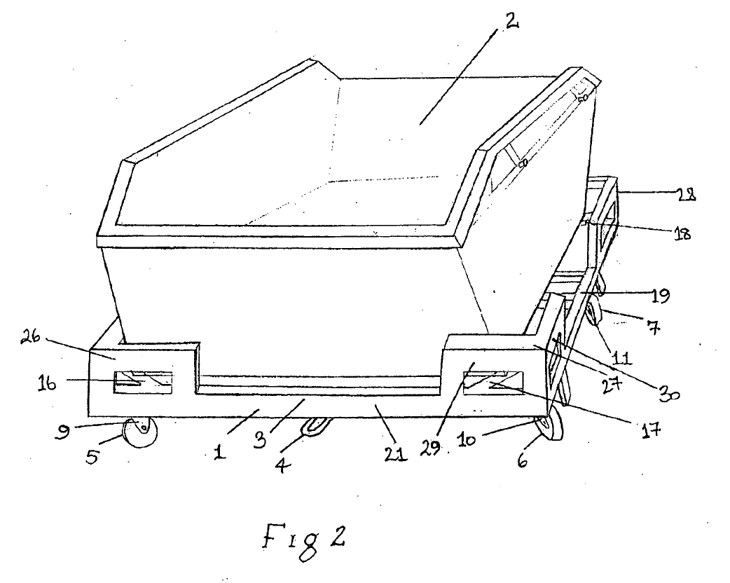

FIG. 2 is a front perspective view of the moveable support and the skip of FIG. 1;

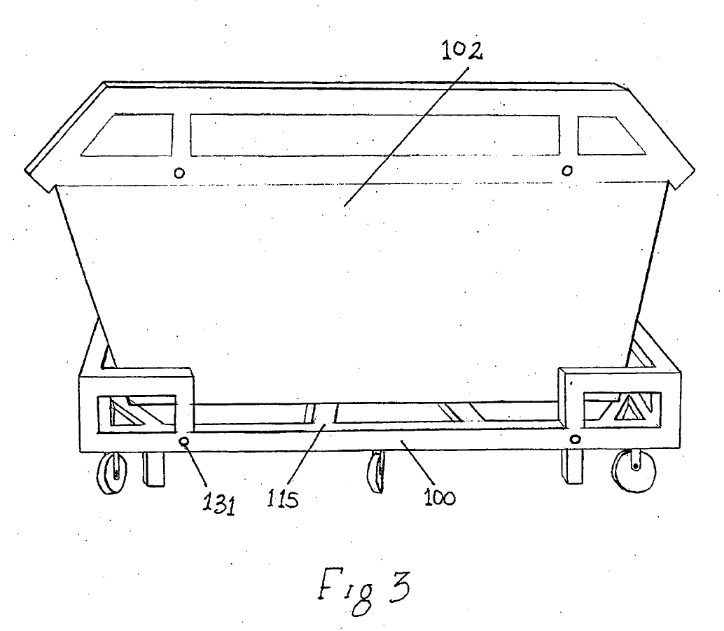

FIG. 3 is a side perspective view of a second embodiment of a moveable support according to a second aspect of the present invention and a skip;

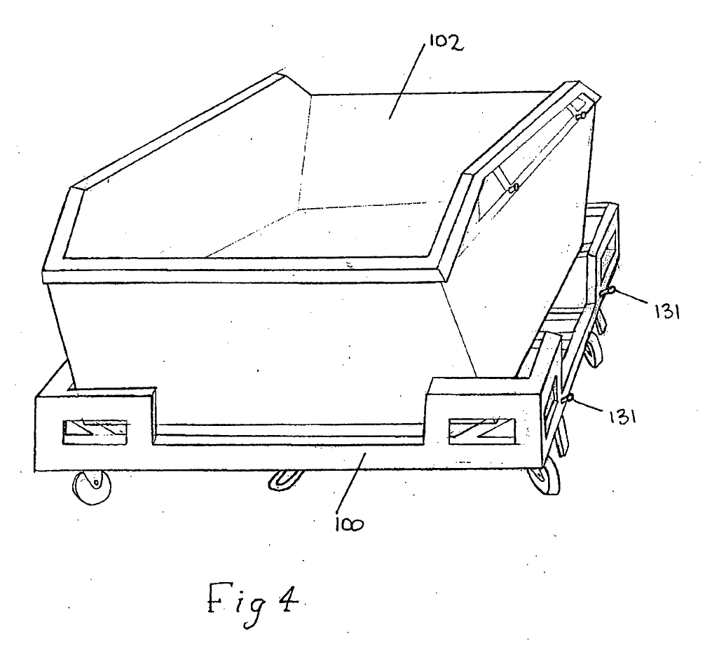

FIG. 4 is a front perspective view of the moveable support and the skip of FIG. 3;

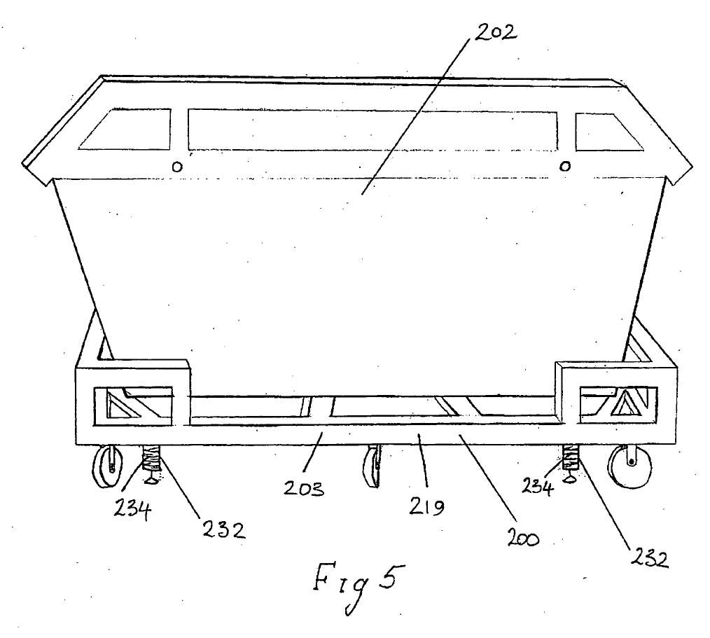

FIG. 5 is a side perspective view of a third embodiment of a moveable support according to a third aspect of the present invention and a skip;

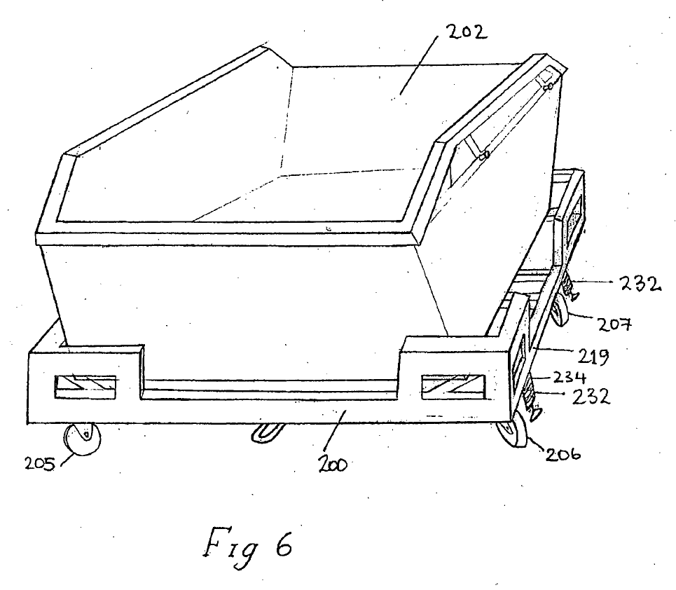

FIG. 6 is a front perspective view of the moveable support and the skip of FIG. 5;

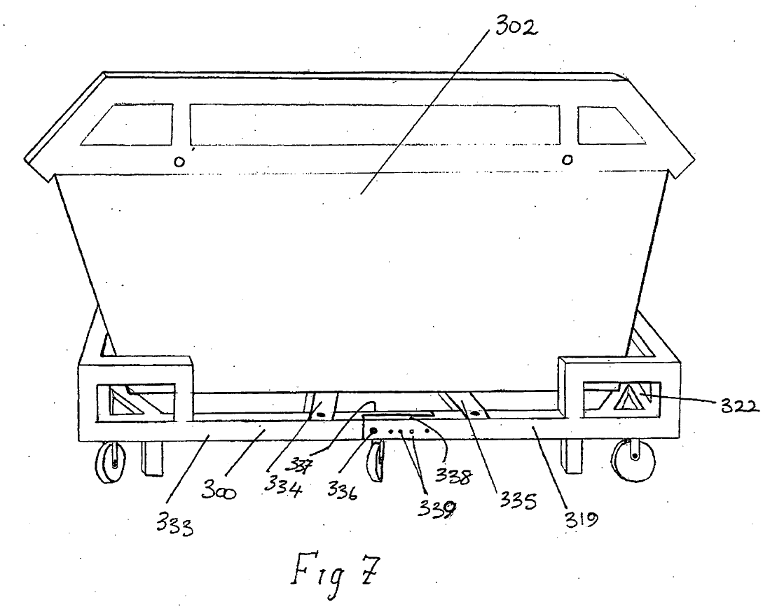

FIG. 7 is a side perspective view of a fourth embodiment of a moveable support according to an aspect of the present invention and a skip;

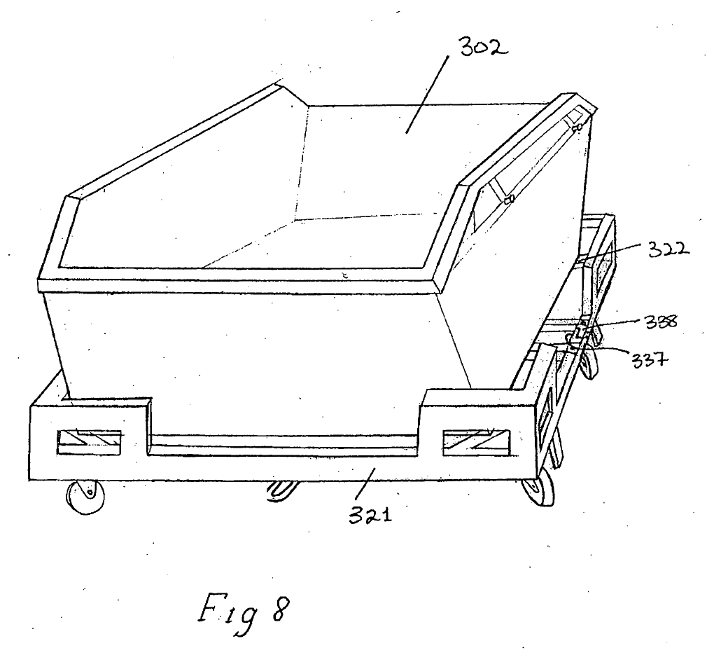

FIG. 8 is a front perspective view of the moveable support and the skip of FIG. 7;

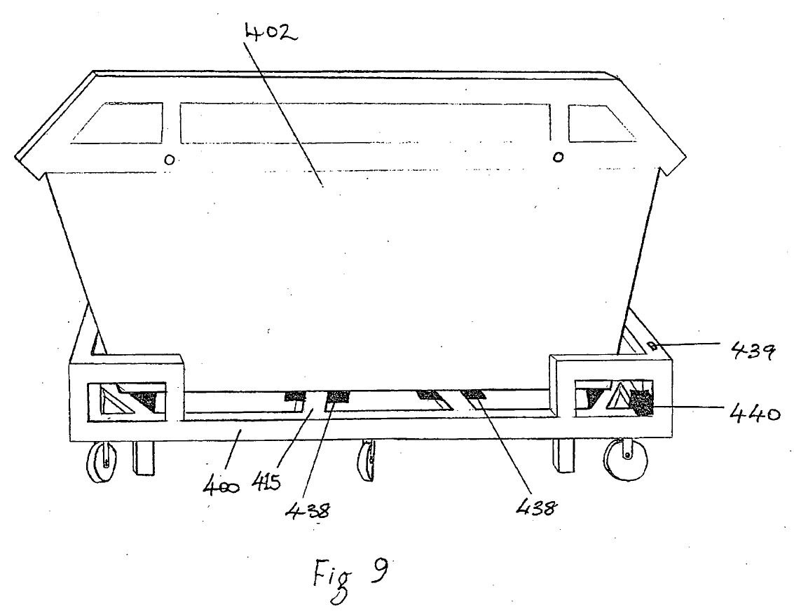

FIG. 9 is a side perspective view of a fifth embodiment of a moveable support according to an aspect of the present invention and a skip;

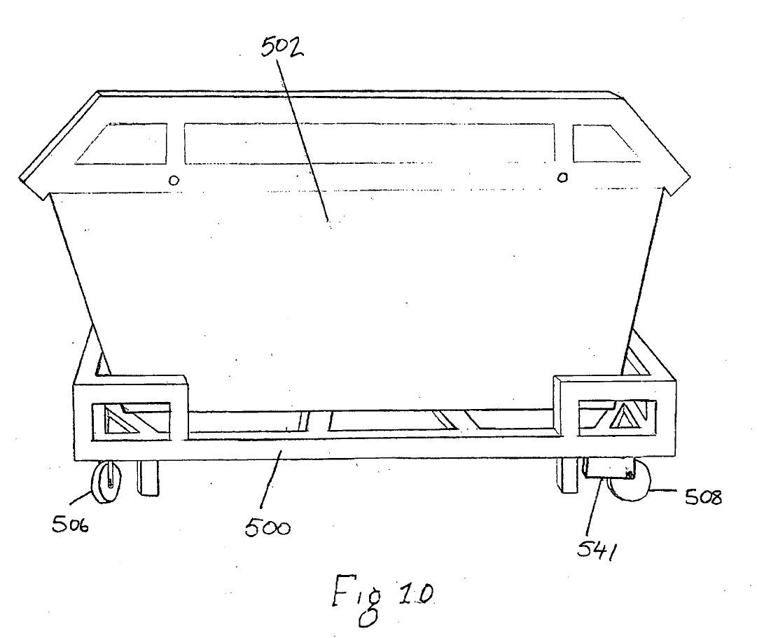

FIG. 10 is a side perspective view of a sixth embodiment of a moveable support according to an aspect of the present invention and a skip; and

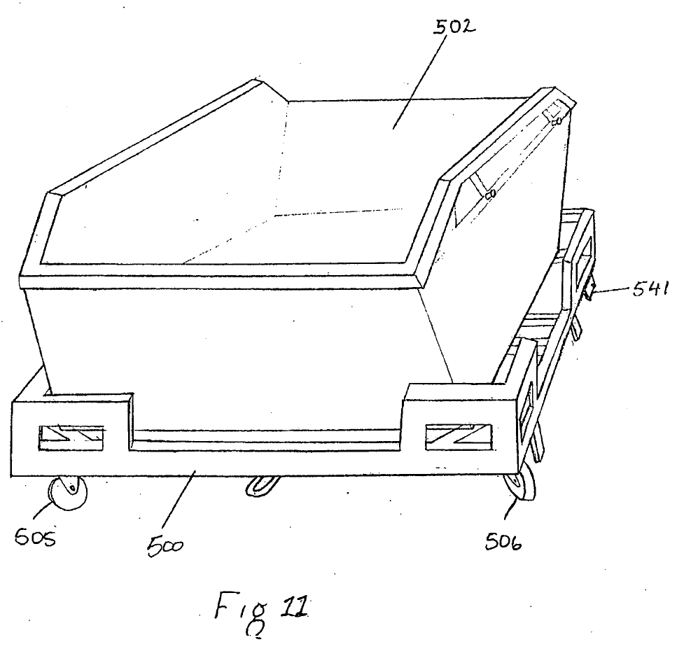

FIG. 11 is a front perspective view of the moveable support and the skip of FIG. 10.

Referring to the drawings, FIGS. 1 and 2 show a moveable support 1 and a skip 2.

The movable support 1 comprises a frame 3, a tow bar 4, front wheels 5,6, centre wheels 7, back wheels 8, rotatable wheel mountings 9,10,11, fixed back wheel mountings 12 and legs 13,14.

It will be appreciated that there are complimentary wheels and wheel mountings to those shown in the Figures on the opposite side of the frame 3. Furthermore, there are complimentary legs (not shown) to those shown in the Figures on the opposite side of the frame 3.

The frame 3 can be made of metal sections which are welded or bolted together.

The frame 3 is rectangular in shape and comprises a rectangular base 15 and four elevated corner portions. Three of the corner portions 16,17,18 are illustrated in the drawings.

The base 15 comprises two longitudinal side sections 19, a lateral front section 21, a lateral rear section 22, corner reinforcing bars 23 and two cross bars 24,25. All of which are typically fabricated from steel having a rectangular cross section.

An end of each of the longitudinal side sections 19 is connected at right angles to the ends of the lateral front section 21. Similarly, an end of each of the longitudinal side sections 19 is connected at right angles to the ends of the lateral rear section 22.

The corner reinforcing bars 23 are connected diagonally across each corner at the connection between adjacent lateral and longitudinal sections 19,21,22.

The two cross bars 24,25 connect longitudinal side sections 19 between the centre of longitudinal side sections 19 and their ends. The cross bars 24,25 are parallel to the lateral side sections 21,22.

Elevated corner portions 26,27,28 are formed at each corner of the base 15, only three corner portions 26,27,28 are shown in the drawings. Each of the elevated corner portions 26,27,28 extend vertically above the base 15. The elevated corner portions 26,27,28 each comprise two U-shaped bars 29,30 which are joined in an L-shape at each corner of the base 15.

In use, the skip 2 is off loaded from a truck onto the moveable support 1. The moveable support 1 bears the weight of the skip 2 and enables the skip 2 to be moved. A small tow truck or other suitable vehicle may be coupled to the moveable support 1 by coupling the tow truck with the tow bar 4. The tow truck may then be used to move the moveable support 1 and the skip 2 as required and generally to another location on site. The skip 2 rests on the cross bars 24,25 and the corner reinforcing bars 23 and is retained in position on the moveable support 1 by the elevated corner portions 26,27,28.

It is also possible to move the moveable support 1 before the skip 2 has been placed on it in the same manner. In fact, it may be possible to move the moveable support 1 by hand when there is no skip loaded on it or if the skip 2 loaded on top of it is empty.

The front wheels 5,6 and centre wheels 7 are mounted on rotatable wheel mountings 9,10,11. These wheels 5,6,7 enable the moveable support 1 to be turned or orientated to move the moveable support 1 in the desired direction. The back wheels 8 are mounted on fixed back wheel mountings 12 and are prevented from rotating in the horizontal plane.

Referring now to FIGS. 3 and 4, an embodiment of the present invention is disclosed that is substantially the same as that shown in FIGS. 1 and 2. Parts of the embodiment of FIGS. 3 and 4 corresponding to parts of the embodiment of FIGS. 1 and 2 are accorded similar reference numerals in the one hundred series.

FIGS. 3 and 4 show the moveable support 100 and the skip 102. The moveable support 100 has lugs 131 on its base 115. The lugs 131 on the moveable support 100 may be used to attach the moveable support 100 to a hoist (not shown) to enable the moveable support 100 and the skip 102 to be lifted onto the truck for removal from site. The moveable support 100 and skip 102 may be set down on site in the same way. This enables the moveable support 100 to be transported by truck to and from various sites as necessary.

Referring now to FIGS. 5 and 6, an embodiment of the present invention is disclosed that is substantially the same as that shown in FIGS. 1 and 2. Parts of the embodiment of FIGS. 5 and 6 corresponding to parts of the embodiment of FIGS. 1 and 2 are accorded similar reference numerals in the two hundred series.

FIGS. 5 and 6 show the moveable support 200 and the skip 202. The moveable support 200 has screw adjustable legs 232. The legs 232 are adjustable by means of a screw thread 234 formed on an outer surface of the legs 232 that engages complimentary threaded openings in the side sections 219 of the frame 203.

The screw adjustable legs 232 of the moveable support 200 may be easily lengthened and shortened by hand. The screw adjustable legs 232 are lengthened in order to enable the moveable support 200 to be supported by the legs 232 instead of the wheels 205,206,207,208. The weight of the skip 202 on the moveable support 200 is then borne by the legs 232. The legs 232 can stabilise the moveable support 200 in this position, which is particularly useful if the moveable support 200 is positioned on a sloping or uneven ground surface. The screw adjustable legs 232 can be shortened when the moveable support 200 is moved so that the legs 232 do not hinder the movement of the wheels 205, 206, 207, 208.

Referring now to FIGS. 7 and 8, an embodiment of the present invention is disclosed that is substantially the same as that shown in FIGS. 1 and 2. Parts of the embodiment of FIGS. 7 and 8 corresponding to parts of the embodiment of FIGS. 1 and 2 are accorded similar reference numerals in the three hundred series.

FIGS. 7 and 8 show the moveable support 300 and the skip 302, the moveable support 300 has an adjustable frame 333 and removable crossbars 334,335. The adjustable frame 333 may be adjusted in size by removing a bolt 336 which secures interleaving portions 337,338 of the longitudinal sides 319 of the frame 333 together. The frame 333 can be adjusted in size by inserting and securing the bolt 336 at a different bolt hole 339 in the frame 333.

The adjustable frame 333 is useful if the moveable support 300 is used with different size skips 302. It will be appreciated that the lateral sides 321,322 of the adjustable frame 333 can also be adjustable to accommodate different sized skips.

Referring now to FIG. 9, an embodiment of the present invention is disclosed that is substantially the same as that shown in FIGS. 1 and 2. Parts of the embodiment of FIG. 9 corresponding to parts of the embodiment of FIGS. 1 and 2 are accorded similar reference numerals in the four hundred series.

FIG. 9 shows the moveable support 400 and the skip 402, the movable support 400 having electromagnetic pads 438 attached to the base 415. A switch 439 on the moveable support 400 can activate a power supply 440 to enable magnetisation of the electromagnetic pads 438. When the electromagnetic pads 438 are magnetised, the base 415 of the frame 403 is attached to the skip 402 by magnetic force. If the skip 402 is then lifted onto the truck, the moveable support 400 is lifted with it. This means that the moveable support 400 does not bear the weight of the skip 402 while being hoisted onto the truck.

Referring now to FIGS. 10 and 11, an embodiment of the present invention is disclosed that is substantially the same as that shown in FIGS. 1 and 2. Parts of the embodiment of FIGS. 10 and 11 corresponding to parts of the embodiment of FIGS. 1 and 2 are accorded similar reference numerals in the five hundred series.

FIGS. 10 and 11 show the moveable support 500 and skip 502. The support 500 has front wheels 505,506 and back wheels 508. The back wheel 508 of the moveable support 500 is attached to a motor 541.

The motor 541 is used to drive the back wheels 508 in order to provide the force or additional force to move the moveable support 500. It will be appreciated that the front wheels 505,506 may be steerable and driveable electrically by attaching a suitable motor to the front wheels 505,506. The back wheels 508 and/or the front wheels 505,506 can be controlled by remote control (not shown) which is connected to the motor(s) 541 by cable. Alternatively, the remote control can be a wireless or radio remote control.

The tow bar 504 can be used to couple the moveable support 500 to a tow truck to enable the moveable support 500 to be moved by the tow truck if the motors 541 fail due to a power supply failure or other fault. The tow bar 504 may also be useful if additional force is required to move the moveable support 500.

It will be appreciated that non mutually exclusive features of the aforementioned embodiments may be interchanged or substituted freely.

While various embodiments of the invention have been described, it will be apparent to those skilled in the art once given this disclosure that various modifications, changes, improvements and variations may be made without departing from the scope of the invention.

1. A moveable support for a waste container, comprising: a frame for supporting the waste container comprising a base and mobilising means.

2. A moveable support as claimed in claim 1, wherein the waste container comprises a skip.

3. A moveable support as claimed in claim 1, wherein the mobilising means comprises at least one wheel.

4. A moveable support as claimed in claim 1, wherein the mobilising means comprises at least one roller.

5. A moveable support as claimed in claim 1, wherein the mobilising means comprises tracks.

6. A moveable support as claimed in claim 1, further comprising at least one leg extending from an underside of the frame to slightly above a lower surface of the mobilising means.

7. A moveable support as claimed in claim 6, wherein at least one of the at least one leg comprises an adjustable leg.

8. A moveable support as claimed in claim 7, wherein the adjustable leg is a screw adjustable leg.

9. A moveable support as claimed in claim 1, wherein the moveable support comprises a tow bar.

10. A moveable support as claimed in claim 1, wherein the frame comprises a rectangular frame.

11. A moveable support as claimed in claim 10, wherein longitudinal sides of the frame are adjustable in length.

12. A moveable support as claimed in claim 10, wherein lateral sides of the frame are adjustable in length.

13. A moveable support as claimed in claim 1, wherein the frame comprises cross bars.

14. A moveable support as claimed in claim 1, wherein the frame comprises removable cross bars.

15. A moveable support as claimed in claim 1, wherein the moveable support comprises at least one lug being attachable to a lifting means.

16. A moveable support as claimed in claim 1, wherein the moveable support comprises a magnetisation means.

17. A moveable support as claimed in claim 16, wherein the magnetisation means comprises an electromagnet, which is selectively actuable.

18. A moveable support as claimed in claim 16, wherein the magnetisation means is arranged to lock the moveable support to the waste container, in use.

19. A moveable support as claimed in claim 1, wherein the moveable support comprises a drive means connected to the mobilising means.

20. A moveable support as claimed in claim 19, wherein the drive means comprises an electric motor or a combustion engine.
